(19) United States
(12) Patent Application Publication
(10) Pub. No.: US 2004/0125074 A1
(43) Pub. Date: Jul. 1, 2004

(54) Multi-function remote controller

(76) Inventor: Chin-Shu Lin, Taipei (TW)

Correspondence Address: Chin-Shu Lin, 235 Chung - Ho, Box 10-69, Taipei, TW

(21) Appl. No.: 10/331,971

(22) Filed: Dec. 31, 2002

(51) Int. Cl. G09G 5/00

(52) U.S. Cl. 345/156

(57) ABSTRACT

A multi-function remote controller comprises a touch panel; a liquid crystal display; a power unit; a microprocessor; a memory unit; an infrared transceiver unit; a carrier emitting and receiving unit; a buzzer; a back light module and control unit; and a transmitting interface. The keys on the touch panel includes device selecting keys, frame switching keys, function setting keys, a delete key, micro instruction set keys, channel keys, operation keys, a power keys, a search keys for performing the functions of general operation, channel classification, micro instruction set, guiding learning; the remote control object is determinable, which includes televisions, video compact disks, DVDs, VCRs. CDs.

### FIELD OF THE INVENTION

The present invention relates to remote controllers, and particularly to a multi-function remote controller capable of executing a plurality of applications so as to enhance ability of the remote controller, these functions such as at least one remote control device can be set and remote control devices can be added or deleted; the remote control code in the memory can be added or set manually or automatically; debug function is added so that the user can collect new remote control codes; and modified firmware can be added to the multi-function remote controller through a network.

### BACKGROUND OF THE INVENTION

Remote controllers are generally used in many home using electric devices, such as air conditioners, TVs, video displays, etc., so as to provide many convenient functions. However, nowadays, it is often that a room has many electric devices, such as an air conditioner, a TV and a video display, etc. Thereby, several remote controllers are used in a room. This induces inconvenience to the users. Moreover, the user takes much time for searching the controller so as to feel inconvenient. Further, the user often takes some time to find a remote controller to control a desired device. To solve above mentioned defects in the prior art, universal remote controllers are developed so that one controller can control a plurality of electric devices. However, this prior art design still has some defects as described hereinafter:

The first defect to be mentioned is that too many keys are installed in the panel. Other than common used keys, many special keys suitable for some special devices are installed on the panel. Moreover, one key has many functions so that the user must take care of it in operation. Although a touch panel having multiple display layers are developed, it uses LCD as a display. The price is high.

The keys of learning and setting are not integrated, and new remote control codes can not be updated in time. The learning is to learn pre-programmed code and setting function is used to set codes by the user. At one learning mode, the user holds the universal remote controller and the remote controller is directed toward the electric device to be remotely controlled. Then a plurality of remote control codes are emitted to the device, after a code set is the codes of the device, the device to be controlled is actuated. For another learning mode, the functions of keys of original remote controls are copied to the universal remote controllers so as to replace the original one.

Moreover, many new remote control codes are developed so that many remote controllers are not be equipped the remote control codes by default or through learning so as to induce some troubles in use.

Another prior art defect is that channels can not be classified so that the operation of selecting a channel is difficult.

One device selecting key selects only one device. If the devices to be controlled are too many, many keys must be equipped on the key pad.

The functions can not be updated so that the current used remote controller can not match many new application built in new developed remote controller.

The infrared remote controllers are only used in a finite space. If one device to be controlled in located at other place, it remote controller becomes useless.

If the remote controller is lost, it is often that the user can not find it easily so that the user takes much time to find it.

### SUMMARY OF THE INVENTION

Accordingly, the primary object of the present invention is to provide a multi-function remote controller comprising: a touch panel having a plurality of keys thereon and is divided into a plurality of touch control sections; a liquid crystal display serving for displaying the conditions of the touch panel and having a driving unit for displaying the control condition; a power unit for supplying power; a microprocessor for controlling the operations of the components of the present invention; a memory unit being an erasable non-volatile memory for storing remote controlling code and control instructions; an infrared transceiver unit; a carrier emitting and receiving unit; a buzzer; a back light module and control unit; and a transmitting interface.

The keys on the touch panel includes device selecting keys, frame switching keys, function setting keys, a delete key, micro instruction set keys, channel keys, operation keys, a power keys, a search keys for performing the functions of general operation, channel classification, micro instruction set, guiding learning; the remote control object is determinable, which includes televisions, video compact disks, DVDs, VCRs. CDs.

In one aspect of the present invention, the device selecting keys sets at least one electric device for controlling a plurality of devices.

In one aspect of the present invention, the frame switching key serves for paging the keys on the touch panel.

In one aspect of the present invention, if it is desired to add a new remote control device, a new function adding key in the function setting keys is pressed, and then the device selecting key is pressed, and then a preset remote control code is set for a remote control device.

In one aspect of the present invention, if it is desired to delete a remote control device, the delete key in the function setting keys is pressed, and then a device selecting key is pressed to delete the remote control device code in a memory.

In one aspect of the present invention, a copy key in the function setting keys is pressed for copy control instructions of a device to be remotely controlled, and then he control instructions are stored in the memory unit.

In one aspect of the present invention, a debug key is set in the function setting keys; the infrared ray (IR) receiving unit serves to receive the data from original remote control codes of the remote controller (RC), and the remote control codes are stored in a memory; and then the data is uplink or downlink as a file through a transfer interface and a personal computer or a network.

In one aspect of the present invention, a PC is used to collect remote control codes of a device and then and transfers the codes to a technology center to analysis the codes and then processed codes by the technology center is returned to the PC and then is sent to the memory unit of the multi-function remote controller so that the remote controller can control the device having the remote control codes.

In one aspect of the present invention, the remote controller collects remote control codes of a device and then transfers the codes to a technology center to analysis the codes and then processed codes are returned to the memory unit of the multi-function remote controller so that the remote controller can control the device with the remote control codes.

In one aspect of the present invention, the channels are classified by pressing the setting function then pressing setting channel classifying keys, then pressing setting device selecting keys to select a remote control device with a channel assigned to the remote control device, and then the channel communicated with the remote control device is input by pressing the channel classifying keys so as to classify the remote control device by channels.

In one aspect of the present invention, a channel classified key is installed on the touch panel; then the data about the classification of the channel in the memory is taken out, and then a channel is selected pressing by a general used channel selecting key on the touch panel.

In one aspect of the present invention, a sleep micro instruction set is included in the micro instruction set; a time interval is set by the sleep micro instruction set; before the time period near the time interval, a plurality of steps for remotely controlling a device are set; the sleep micro instruction set includes a timing setting function.

In one aspect of the present invention, the micro instruction set is connected to the buzzer, a search device emits signals to the multi-function remote controller, when the multi-function remote controller receive the signals; the buzzer emits buzz voice; the buzz voice is gradually amplified with time elapsed.

In one aspect of the present invention, the multi-function remote controller emits signals from the RF carrier emitting and receiving unit to a signal convert unit for converting the received RF signals into infrared s(IF) signals.

In one aspect of the present invention, the liquid crystal display has a back light module for detecting illumination of incident light; then a control switch is used to actuate back light or the back light is actuated manually.

In one aspect of the present invention, two multi-function remote controllers can transfer remote control codes to one another or transfer data to one another.

In one aspect of the present invention, the operation conditions are displaced on the LCD display.

The various objects and advantages of the present invention will be more readily understood from the following detailed description when read in conjunction with the appended drawing.

### BRIEF DESCRIPTION OF THE DRAWINGS

FIG. 1 is a schematic view showing the construction of the multi-function remote controller of the present invention.

FIG. 2 is an operation flow diagram for device selection of the present invention.

FIG. 3 is a flow diagram for frame switching according to the present invention.

FIG. 4 is a flow diagram showing the operation of adding a new device according to the present invention.

FIG. 5 is a flow diagram showing the operation of deleting device according to the present invention.

FIG. 6 is a flow diagram showing the operation of duplication of a device according to the present invention.

FIG. 7 is a flow diagram showing the collection of remote control codes according to the present invention (no learning ability).

FIG. 8 is a flow diagram showing the collection of remote control codes according to the present invention (at PC end).

FIG. 9 is a flow diagram showing the transfer and update of PC data through a PC according to the present invention.

FIG. 10 is a flow diagram showing that the data transfer and update through the multi-function remote controller of the present invention.

FIG. 11 is a flow diagram showing that the present invention can be used to classify channels.

FIG. 12 is a flow diagram showing the searching of classified channel according to the present invention.

FIG. 13 is a flow diagram showing that the present invention performs a sleep micro sets.

FIG. 14 is a flow diagram showing the search of the remote control according to the present invention.

FIG. 15 is a schematic view showing the comparison of the IR code far end control of the present invention with the prior art.

FIG. 16 is a flow diagram showing the IR code far end control of the present invention.

### DETAILED DESCRIPTION OF THE PREFERRED EMBODIMENTS

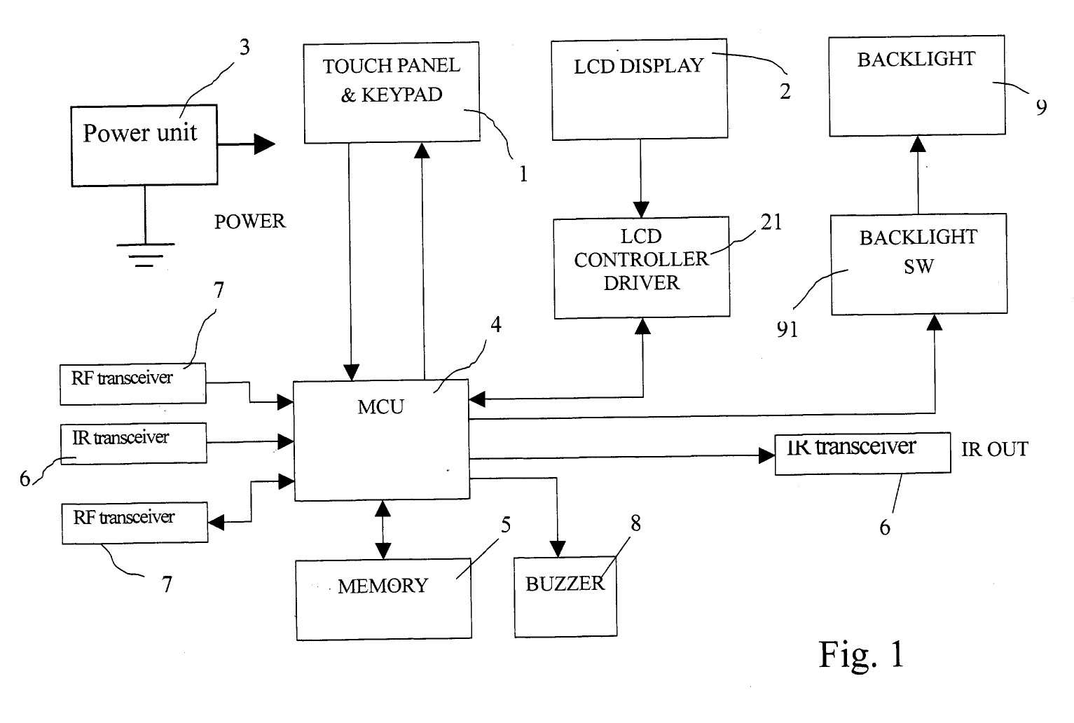

Referring to FIG. 1, the multi-function remote controller of the present invention is illustrated. The multi-function remote controller comprises the following components.

A touch panel 1 has a keypad with a plurality of keys thereon and is divided into a plurality of touch control sections.

A liquid crystal display 2 serves for displaying the conditions of the touch panel and has a driving unit 21 for displaying the control condition.

A power unit 3 for supplying power to other components of the multi-function remote controller.

A microprocessor 4 serves for controlling the operations of the components of the present invention.

A memory unit 5 is an erasable non-volatile memory for storing remote controlling code and control instructions.

An infrared transceiver unit 6.

An RF carrier emitting and receiving unit 7.

A buzzer 8.

A back light module and control unit 9.

A transmitting interface 10.

The LCD display 2 is connected to the microprocessor 4 through a controller driver 21, and all other components are connected to microprocessor directly or indirectly for being controlled by the microprocessor.

In the present invention, the touch panel 1 is connected to the microprocessor, and

A keys on the touch panel 1 includes device selecting keys (bank keys), frame switching keys, function setting keys, a delete key, micro instruction set keys, channel keys, operation keys, a power keys, a search keys for performing the functions of general operation, channel classification, micro instruction set, guiding learning. The remote control object is determinable, which includes televisions, video compact disks, DVDs, VCRs. CDs.

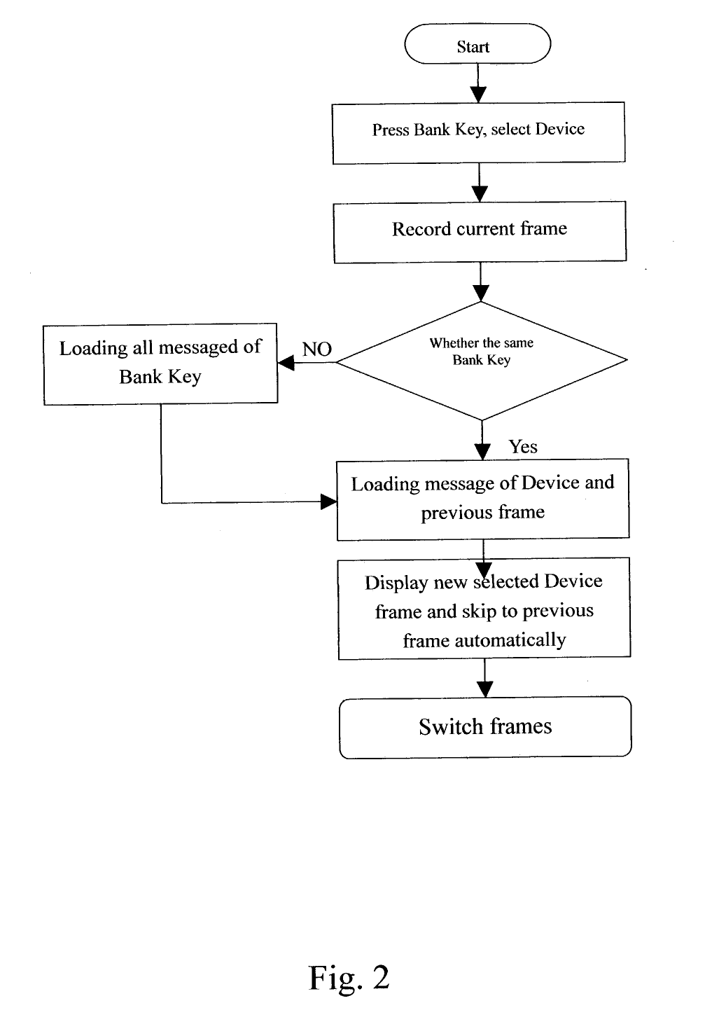

The device selecting keys can set at least one electric device for controlling a plurality of devices. Thereby, a plurality of devices can be controlled by the controller of the present invention, as shown in FIG. 2.

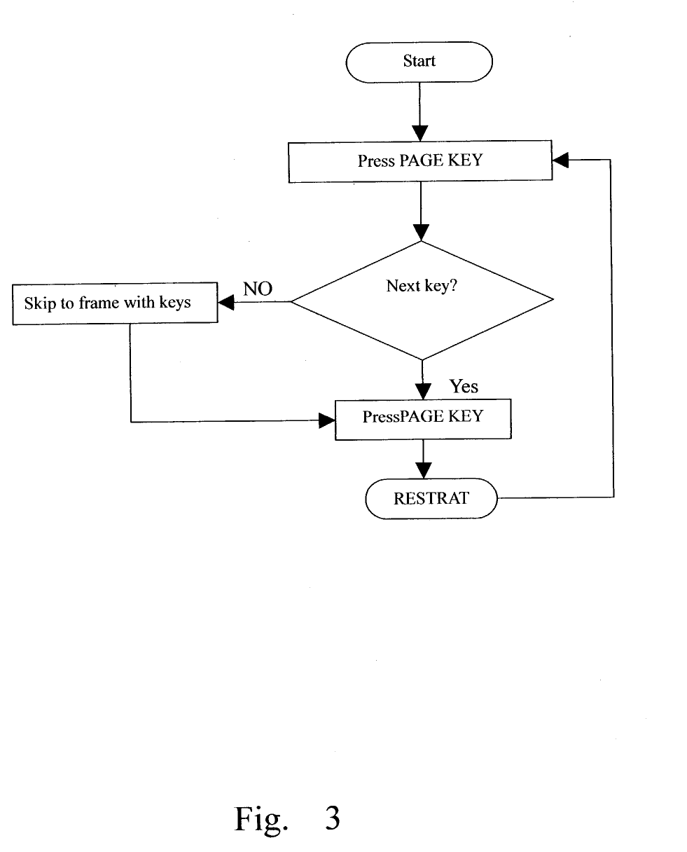

The frame switching key serves for paging the keys on the touch panel. As shown in FIG. 3, an operation frame for selecting remote controller object is selected and then all the information about the object to be remotely controlled is loaded. Thereby, only a few keys are used and the volume of the multi-function remote controller is reduced. Thereby, more keys can be mounted on the keypad and the keys can be divided into several pages.

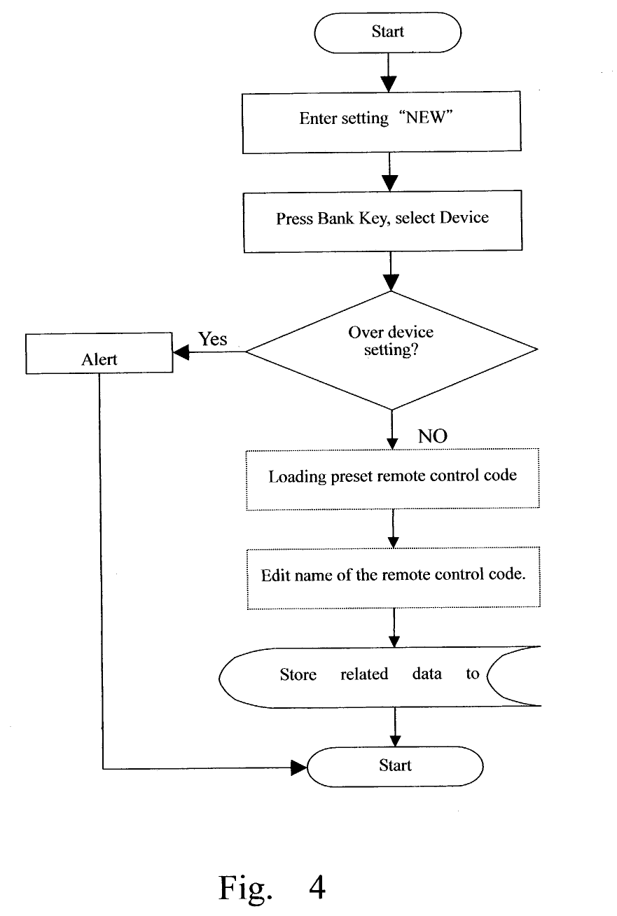

Referring to FIG. 4, if it is desired to add a new remote control device, a new function adding key in the function setting keys is pressed, and then the device selecting key is pressed, and then a preset remote control code is set for a remote control device.

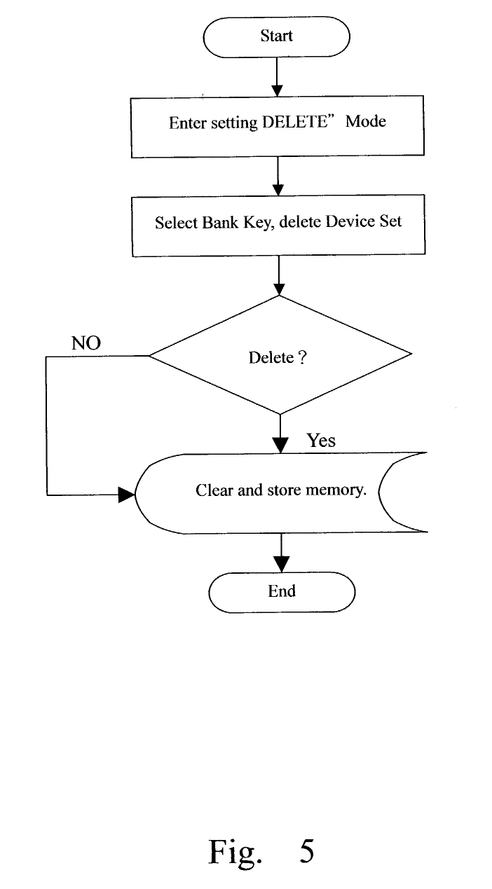

Referring to FIG. 5, if it is desired to delete a remote control device, the delete key in the function setting keys is pressed, and then a device selecting key is pressed to delete the remote control device code in a memory.

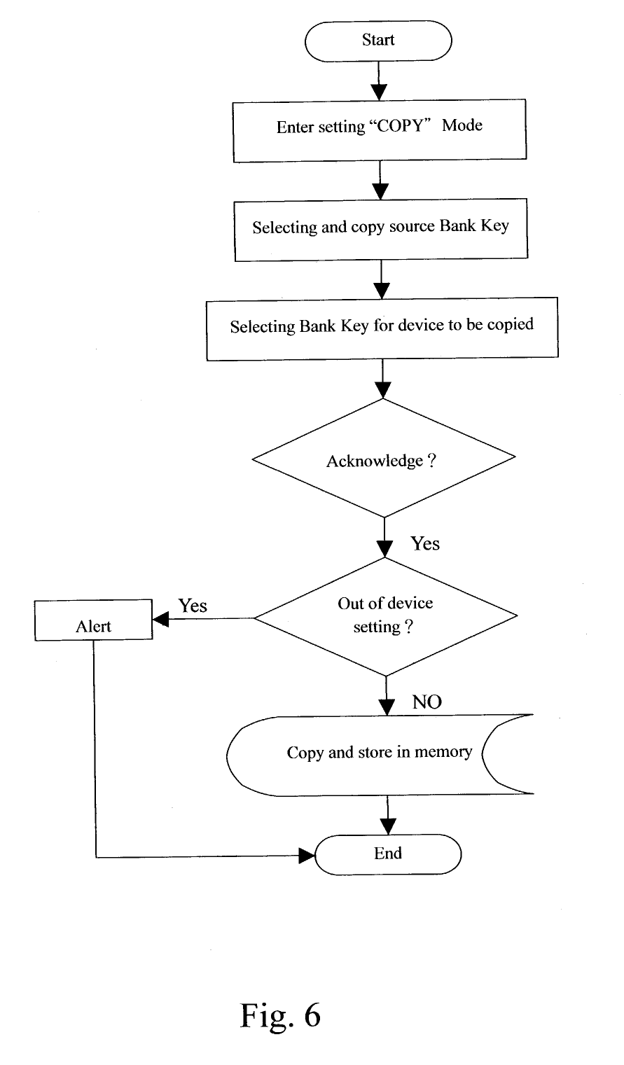

Referring to FIG. 6, the user can press the copy key in the function setting keys for copy control instructions of the current used device to be remotely controlled, and then he control instructions are stored in the memory.

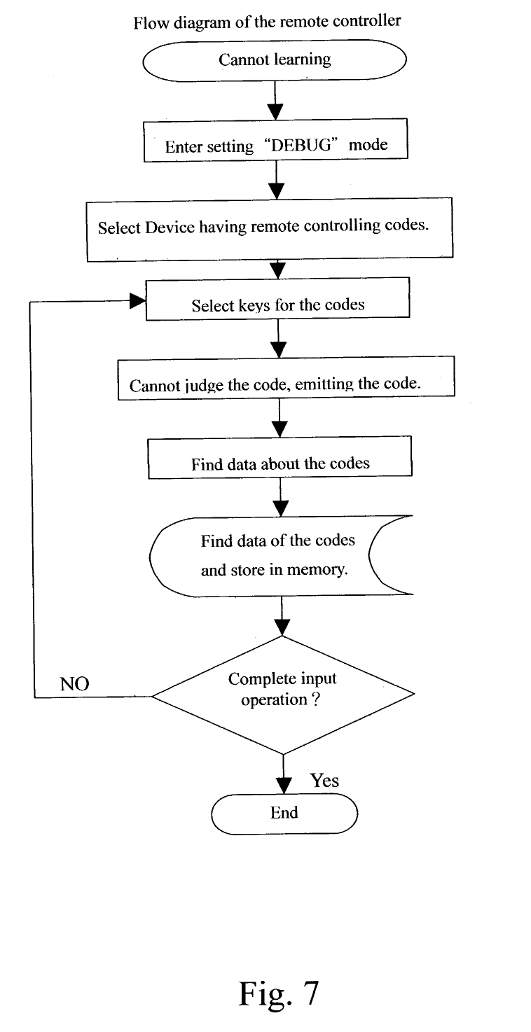

Referring to FIG. 7, a debug key is set in the function setting keys. Infrared ray (IR) receiving unit 6 serves to receive the data from the original remote control codes of a remote controller (RC), and the the RC codes are stored in a memory 5. Then the data is uplink or downlink as a file through a transfer interface 10 and a personal computer or a network.

Referring to FIG. 8, a PC is used to collect remote control codes of a device and then transfers the codes to a technology center to analysis the codes and then processed codes are returned to the PC and then is returned to the memory unit 5 of the multi-function remote controller of the present invention so that the remote controller can control the device with the remote control codes.

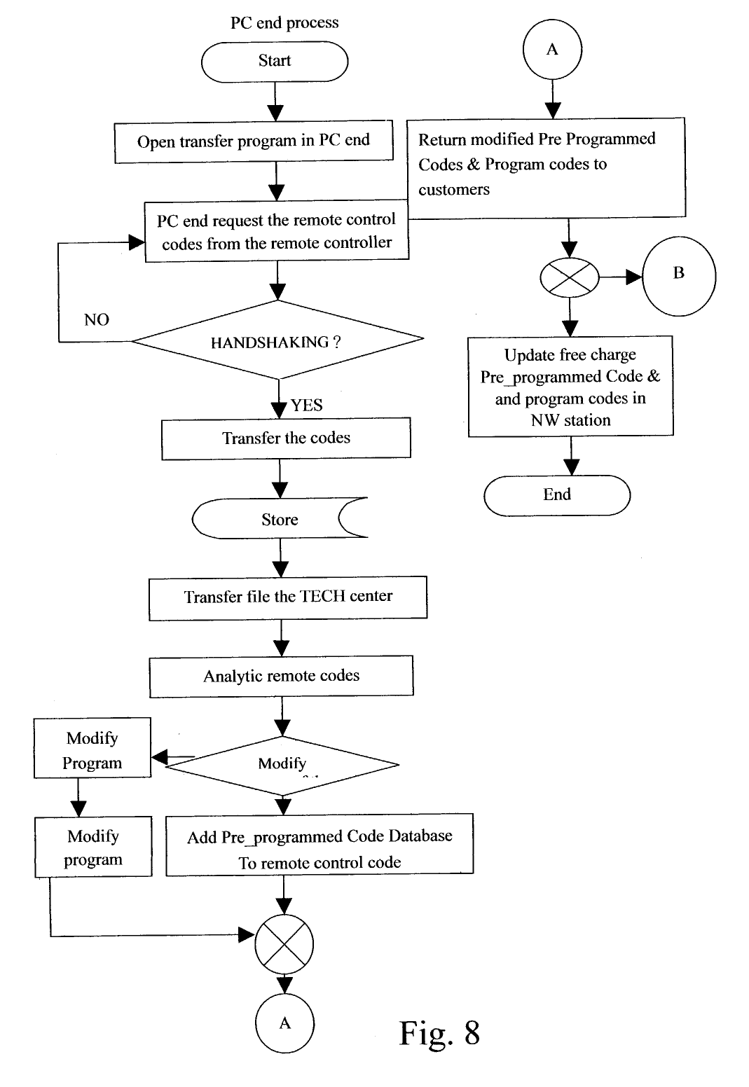

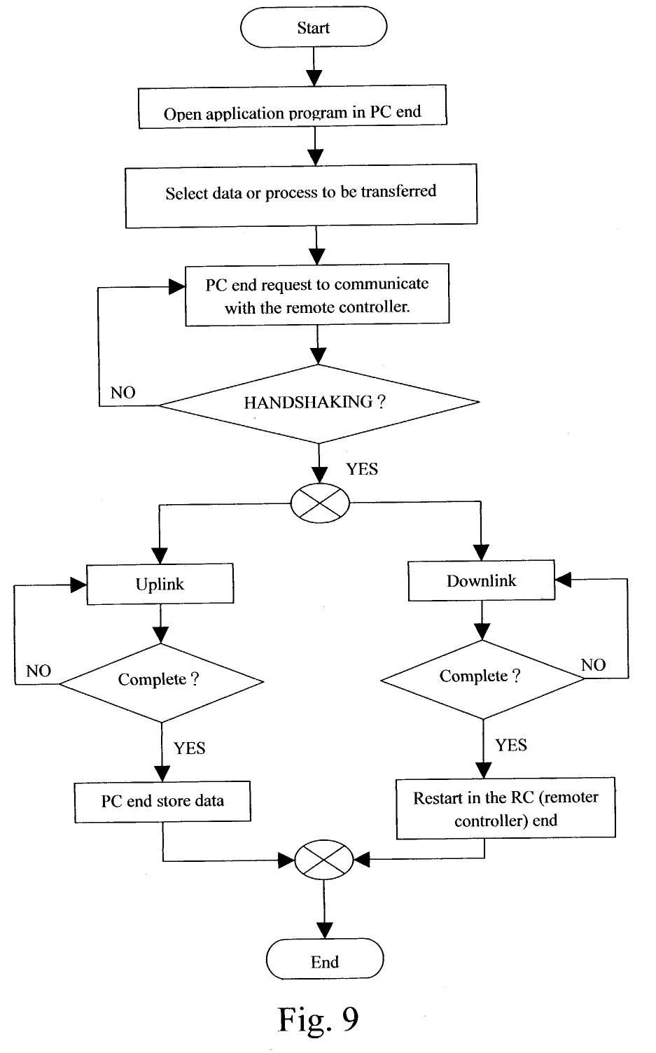

Referring to FIG. 9, the remote controller of the present invention collects remote control codes of a device and then transfers the codes to a technology center to analysis the codes and then processed codes are returned to the memory unit 5 of the multi-function remote controller of the present invention so that the remote controller can control the device with the remote control codes.

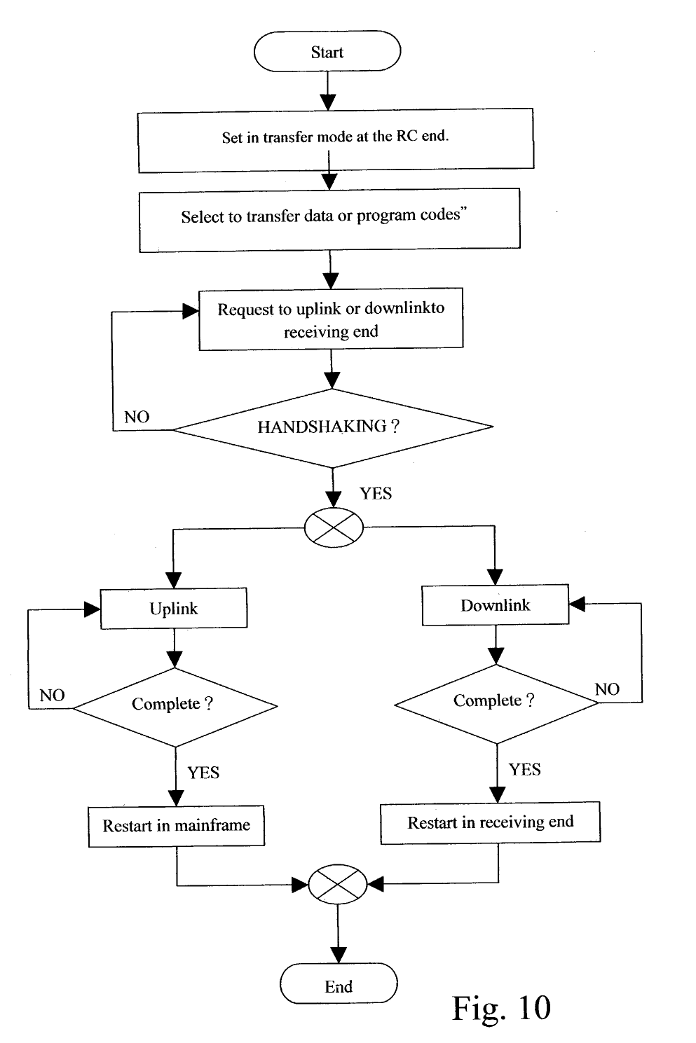

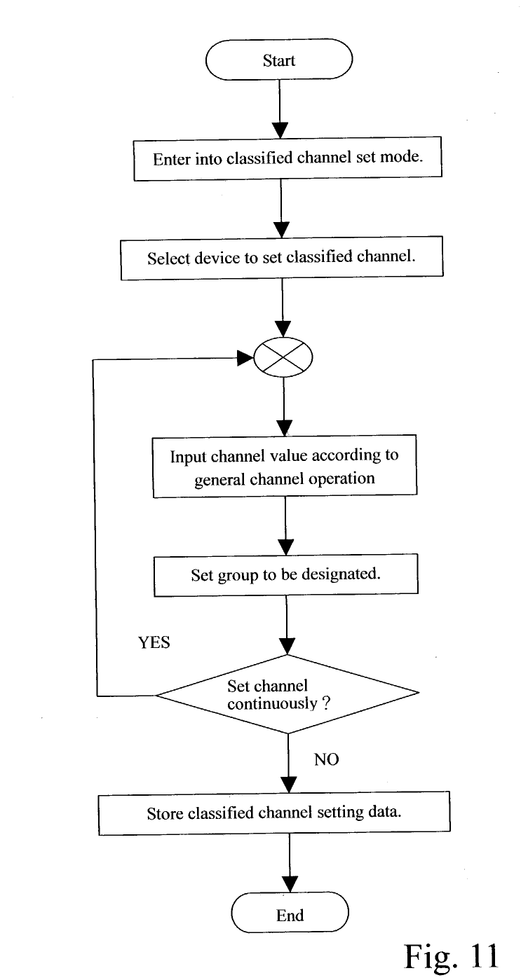

Referring to FIG. 10, the channels are classified by pressing the setting function and then setting channel classifying keys, then setting device selecting keys to select a remote control device with a channel assigned to the remote control device, and then the channel is input by pressing the channel classifying keys so as to classify the remote control device by channels.

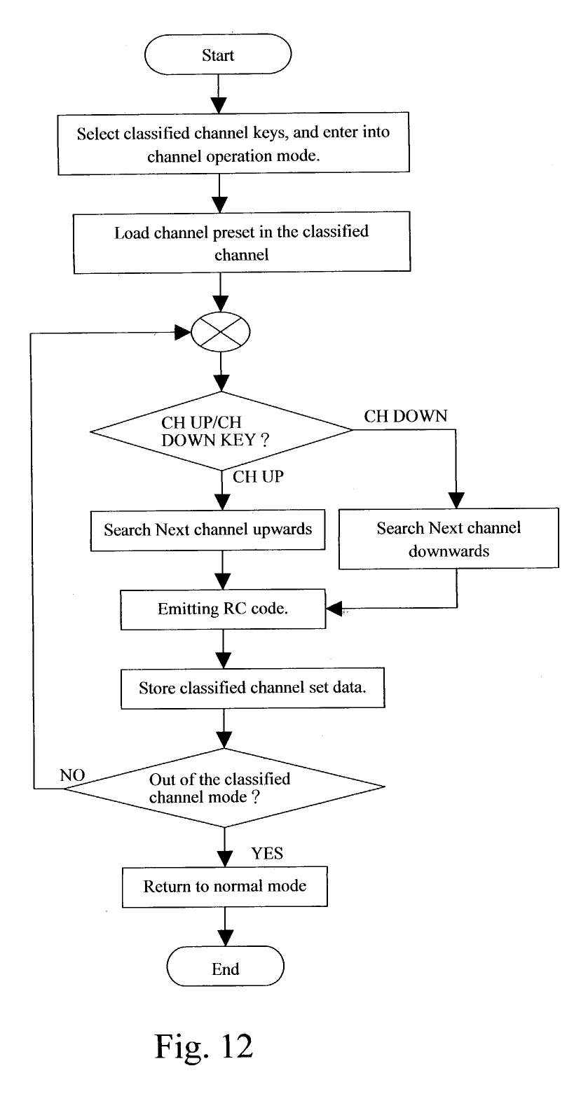

Referring to FIG. 12, the use of classifying channel is illustrated. In this embodiment, a channel classified key is installed on the touch panel 1. Then the data about the classification of the channel in the memory 5 is taken out, and then a channel is selected by a general used channel selecting key.

With reference to FIG. 13, a sleep micro instruction set is included in the process micro instruction set. A time interval is set by the sleep micro instruction set. Before the time period near the time interval, a plurality of steps for remote controlling a device are set (referring to FIG. 13). The sleep micro instruction set includes a timing setting function.

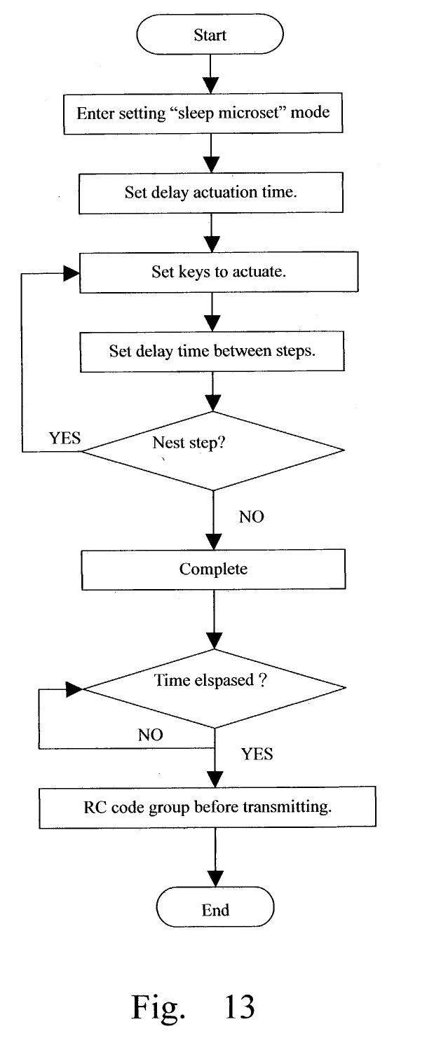

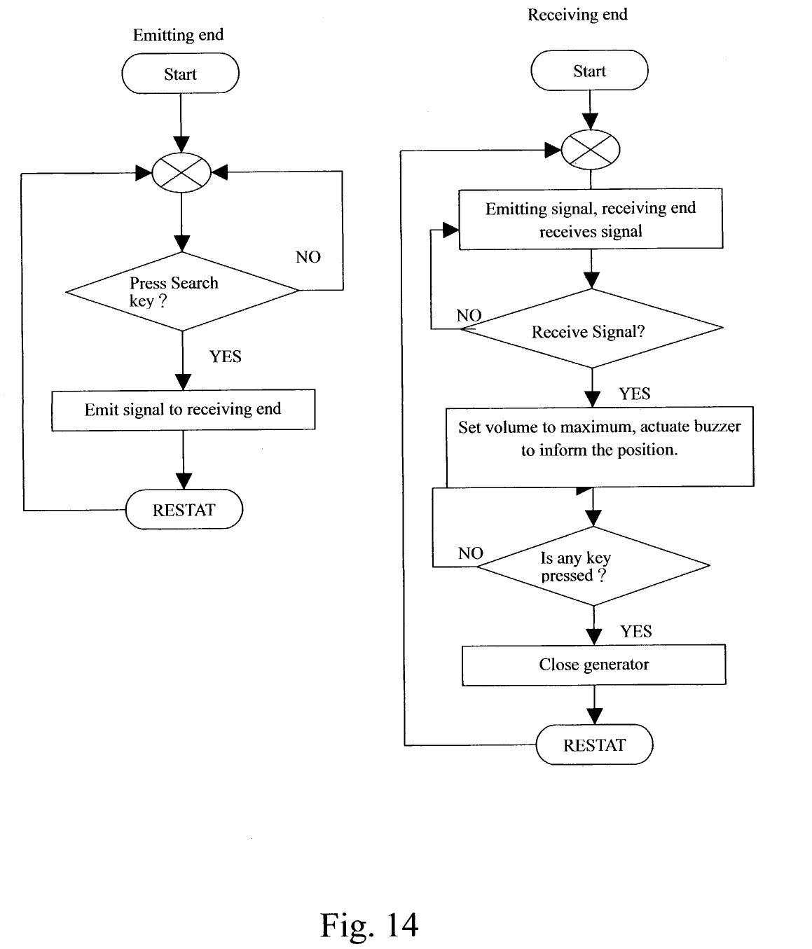

With reference to FIG. 14, the micro instruction set is connected to the buzzer 8, a device emits signals to the multi-function remote controller of the present invention, when the multi-function remote controller receive the signals. The buzzer emits buzz voice. The buzz voice is gradually amplified with time elapse.

Moreover, referring to FIGS. 15, and 16, the multi-function remote controller emits signals from the RF carrier emitting and receiving unit 7 to a signal convert unit for converting the received RF signals into infrared s(IF) signals.

The liquid crystal display 2 of the present invention has a back light module 9 for detecting illumination of incident light. Then a control switch 91 is used to actuate back light or the back light can be actuated manually.

The multi-function remote controller as claimed in claim 1, wherein two multi-function remote controllers can transfer remote control codes to one another or transfer data to one another.

The multi-function remote controller as claimed in claim 1, wherein the operation conditions are displaced on the LCD display.

The advantage of the present invention will be described herein.

At least one remote control device can be set and remote control devices can be added or deleted.

The remote control code in the memory can be added or set manually or automatically.

Debug function is added so that the user can collect new remote control codes.

The modified firmware can be added to the multi-function remote controller of the present invention through a network.

Two devices can transfer data through the multi-function remote controller of the present invention.

The micro instruction set has a delay instruction so that the user can understand the condition.

The channels can be classified.

At least two pages of LCD key display frame can be set.

The multi-function remote controller can be searched through a buzzer to the multi-function remote controller to emit voice.

The remote control codes can change their formats.

The sleep micro instruction set can set some steps before sleep.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-function remote controller comprising:
a touch panel having a plurality of keys thereon and is divided into a plurality of touch control sections;
a liquid crystal display serving for displaying the conditions of the touch panel and having a driving unit for displaying the control condition;
a power unit for supplying power;
a microprocessor for controlling the operations of the components of the present invention;
a memory unit being an erasable non-volatile memory for storing remote controlling code and control instructions;
an infrared transceiver unit;
a carrier emitting and receiving unit;
a buzzer;
a back light module and control unit; and
a transmitting interface;
wherein the power unit provides power to the components of the multi-function remote controller; and all components are connected to microprocessor directly or indirectly for being controlled by the microprocessor
wherein keys on the touch panel includes device selecting keys, frame switching keys, function setting keys, a delete key, micro instruction set keys, channel keys, operation keys, a power keys, a search keys for performing the functions of general operation, channel classification, micro instruction set, guiding learning; the remote control object is determinable, which includes televisions, video compact disks, DVDs, VCRs. CDs.

2. The multi-function remote controller as claimed in claim 1, wherein the device selecting keys sets at least one electric device for controlling a plurality of devices; thereby, a plurality of devices are controlled by the controller of the present invention.

3. The multi-function remote controller as claimed in claim 1, wherein the frame switching key serves for paging the keys on the touch panel; only a few keys are used and the volume of the multi-function remote controller is reduced and more keys are be mounted on the keypad and the keys can be divided into several pages.

4. The multi-function remote controller as claimed in claim 1, wherein if it is desired to add a new remote control device, a new function adding key in the function setting keys is pressed, and then the device selecting key is pressed, and then a preset remote control code is set for a remote control device.

5. The multi-function remote controller as claimed in claim 1, wherein if it is desired to delete a remote control device, the delete key in the function setting keys is pressed, and then a device selecting key is pressed to delete the remote control device code in a memory.

6. The multi-function remote controller as claimed in claim 1, wherein a copy key in the function setting keys is pressed for copy control instructions of a device to be remotely controlled, and then he control instructions are stored in the memory unit.

7. The multi-function remote controller as claimed in claim 1, wherein a debug key is set in the function setting keys; the infrared ray (IR) receiving unit serves to receive the data from original remote control codes of the remote controller (RC), and the remote control codes are stored in a memory; and then the data is uplink or downlink as a file through a transfer interface and a personal computer or a network.

8. The multi-function remote controller as claimed in claim 1, wherein a PC is used to collect remote control codes of a device and then and transfers the codes to a technology center to analysis the codes and then processed codes by the technology center is returned to the PC and then is sent to the memory unit of the multi-function remote controller so that the remote controller can control the device having the remote control codes.

9. The multi-function remote controller as claimed in claim 1, wherein the remote controller collects remote control codes of a device and then transfers the codes to a technology center to analysis the codes and then processed codes are returned to the memory unit of the multi-function remote controller so that the remote controller can control the device with the remote control codes.

10. The multi-function remote controller as claimed in claim 1, wherein the channels are classified by pressing the setting function then pressing setting channel classifying keys, then pressing setting device selecting keys to select a remote control device with a channel assigned to the remote control device, and then the channel communicated with the remote control device is input by pressing the channel classifying keys so as to classify the remote control device by channels.

11. The multi-function remote controller as claimed in claim 1, wherein a channel classified key is installed on the touch panel; then the data about the classification of the channel in the memory is taken out, and then a channel is selected pressing by a general used channel selecting key on the touch panel.

12. The multi-function remote controller as claimed in claim 1, wherein a sleep micro instruction set is included in the process micro instruction set; a time interval is set by the sleep micro instruction set; before the time period near the time interval, a plurality of steps for remotely controlling a device are set; the sleep micro instruction set includes a timing setting function.

13. The multi-function remote controller as claimed in claim 1, wherein the micro instruction set is connected to the buzzer, a search device emits signals to the multi-function remote controller, when the multi-function remote controller receive the signals; the buzzer emits buzz voice; the buzz voice is gradually amplified with time elapsed.

14. The multi-function remote controller as claimed in claim 1, wherein the multi-function remote controller emits signals from the RF carrier emitting and receiving unit to a signal convert unit for converting the received RF signals into infrared s(IF) signals.

15. The multi-function remote controller as claimed in claim 1, wherein the liquid crystal display has a back light module for detecting illumination of incident light; then a control switch is used to actuate back light or the back light is actuated manually.

16. The multi-function remote controller as claimed in claim 1, wherein two multi-function remote controllers can transfer remote control codes to one another or transfer data to one another.

17. The multi-function remote controller as claimed in claim 1, wherein the operation conditions are displaced on the LCD display.
